(19) United States
(12) Patent Application Publication
(10) Pub. No.: US 2008/0040386 A1
(43) Pub. Date: Feb. 14, 2008

(54) SHARED PERSONALIZED AUTO-OPEN WORK SCHEDULER SYSTEM AND METHOD

(75) Inventor: Hector Stuart GODLEY, Hsinchu (TW)

Correspondence Address: HAYNES AND BOONE, LLP, 901 Main Street, Suite 3100, Dallas, TX, 75202, US

(73) Assignee: TAIWAN SEMICONDUCTOR MANUFACTURING COMPANY, LTD., Hsin-Chu (TW)

(21) Appl. No.: 11/463,746

(22) Filed: Aug. 10, 2006

(51) Int. Cl. G06F 17/00

(52) U.S. Cl. 707/104.1

(57) ABSTRACT

System and method for implementing a shared personalized auto-open work scheduler are described. In one embodiment, a method for implementing an auto-open work scheduler system comprises creating a work group comprising a plurality of members, wherein the creating further comprises providing for each of the members an e-mail address and a PC-ID identifying a computer of the member; sending to each of the members an e-mail message, the e-mail message comprising means for enabling the member to install a plug-in module on a computer of the member; determining whether all of the members have installed the plug-in module; and responsive to a determination that at least one of the members has not installed the plug-in module, sending a reminder e-mail message to the at least one of the members.

### BACKGROUND

Today, individuals are faced with the challenge of keeping track of multiple personal and work-related tasks, many of which are scheduled to be completed on a timely (e.g., daily, weekly, monthly) basis. Reminders may be provided by various means, such as e-mail, but such reminders are easily overlooked, forgotten, or accidentally deleted due to overloaded e-mail accounts and other factors.

Additionally, work groups often need to synchronize efforts to ensure effective communication and focus on a project or task. Work group members often get distracted performing other tasks, causing them to lose focus on which tasks are of the highest priority to complete.

### BRIEF DESCRIPTION OF THE DRAWINGS

The features and advantages of a shared personalized auto-open works scheduler system and method in accordance with an embodiment will be more clearly understood from the following description taken in conjunction with the accompanying drawings in which like reference numerals designate similar or corresponding elements, regions, and portions, and in which:

FIG. 1 is a block diagram of an environment in which an Auto-Open Work Scheduling System (“AOWSS”) may be advantageously employed in accordance with one embodiment.

FIG. 2 is a block diagram illustrating an embodiment of a method for creating a work group for use in connection with the AOWSS.

FIG. 3 is a flow diagram of the method for creating a work group for use in connection with the AOWSS illustrated in FIG. 2.

FIG. 4 illustrates a management interface for scheduling auto-open items to be auto-opened using the AOWSS.

FIG. 5 is a flow diagram of a method implemented by the AOWSS for auto-opening items scheduled to be auto-opened using the management interface of FIG. 4.

### DETAILED DESCRIPTION

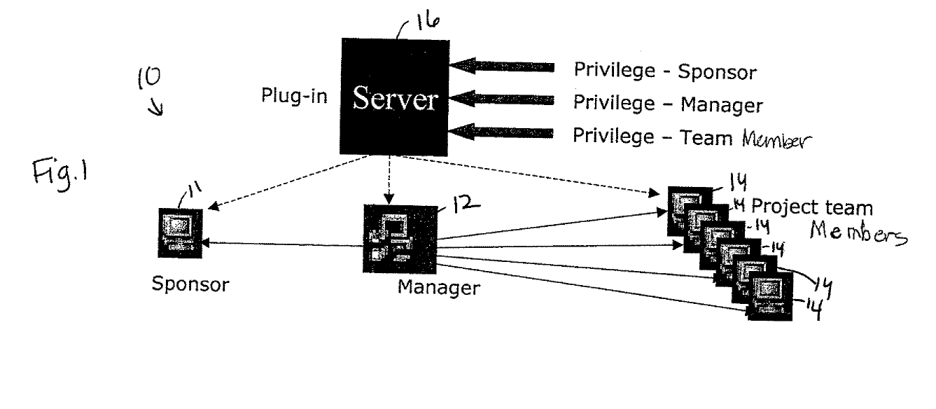

FIG. 1 illustrates an environment in which an auto-open work scheduler of one embodiment may be advantageously implemented. As shown in FIG. 1, members of a work group 10 may include a sponsor 11, a manager 12, and a plurality of users, or team members, 14. In one embodiment, the sponsor 11 selects the manager 12, who then selects the various team members 14. As used herein, the terms “sponsor”, “manager”, and “team member” may be used to designate the persons to whom those roles are assigned, as well as the desktop computing environments of those persons. The sponsor 11, manager 12, and team members 14 are connected, either directly or indirectly, to a server 16 through which they are afforded access to an Auto-Open Work Scheduler System, or “AOWSS” (not shown in FIG. 1), in accordance with privileges granted them by virtue of their role (e.g., “sponsor”, “manager”, “team member”). For example, members of the work group 10 can map to the AOWSS, open it, and download a plug-in to their desktop environment. The privileges granted to a member of the work group 10 will enable them to use the plug-in in different manners. In general, there will be hierarchical relationship among the privilege roles of the sponsor, manager, and team members vis-à-vis the AOWSS. Typically, the sponsor role will have associated therewith the most privileges, the team member role will have associated therewith the least privileges, and the manager role will have associated therewith more privileges than the team member role but fewer privileges than the sponsor role.

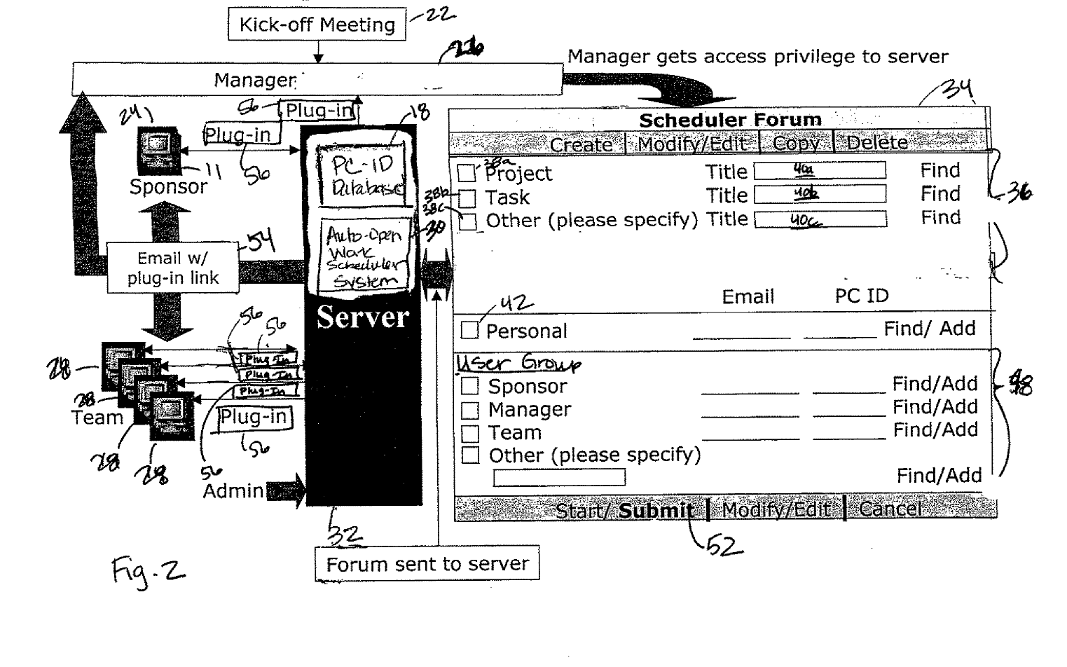

Referring now to FIG. 2, typically during an organizational, or kick-off, meeting 22 in connection with a new project or task to be undertaken by a sponsor 24, the sponsor will designate a manager 26 for the project or task. In addition, team members 28 may be identified during the meeting 22. In accordance with one embodiment, following the meeting 22, the manager 26 is granted access to an Auto-Open Work Scheduler System (“AOWSS”) 30 stored on a server 32. The manager 26 accesses a scheduler forum 34 of the AOWSS 30 and uses the scheduler forum 34 to set up the project or task. In particular, using a first section 36 of the scheduler forum 34, the manager 26 can indicate how the project or task is to be identified. It will be noted that in the illustrated embodiment, the manager 26 can elect to designate the project as a “Project”, a “Task”, or “Other”, by selecting the corresponding check box 38a, 38b, or 38c. The manager 26 also indicates a name, or “Title” of the project by entering same in the corresponding field 40a, 40b, or 40c. It will be recognized that how one defines a “project” as opposed to a “task” will likely be based on subjective criteria; that is, what one person might designate as a “task”, another might designate as a “project”. In addition to being used to create a project or task and associate a work group therewith, the scheduler forum 34 can also be used to modify/edit, copy, or delete an existing task or project and associated work group. As will be described in greater detail below, the manager 26 can also set up a personal project or task by selecting a check box 42.

Using a second section 48 of the scheduler forum 34, the manager 26 enters identifying information for all of the work group members. In particular, the manager 26 enters an e-mail address and PC ID (which is stored in a PC-ID database 18 of the server 32) for each work group member in the appropriate space. Once all of the necessary information has been entered, the data is submitted to the server 32 by clicking on a submit link 52. In general, only the manager and sponsor roles will have access to the scheduler forum 34.

When the AOWSS 30 receives the scheduler forum 34, it sends an e-mail 54 to each of the designated group members (i.e., the sponsor 24, the manager 26, and the team members 28) containing a link to a plug-in 56 associated with the AOWSS 30. When a recipient of the e-mail 54 clicks on the link, the plug-in 56 is downloaded to and installed on the recipient's computer. As will be described in greater detail below, installation of the plug-in 56 on a user's computer enables the AOWSS 30 to auto-open and display on the computer pop-ups the content and timing of which are controlled by the manager 26. In one aspect, if a recipient fails to install the plug-in 56 on his computer in the manner described above within a predetermined time period (e.g., 24 hours), a reminder e-mail will be sent to the recipient. This reminder process will be repeated periodically (e.g., every 24 hours) until installation of the plug-in 56 is confirmed.

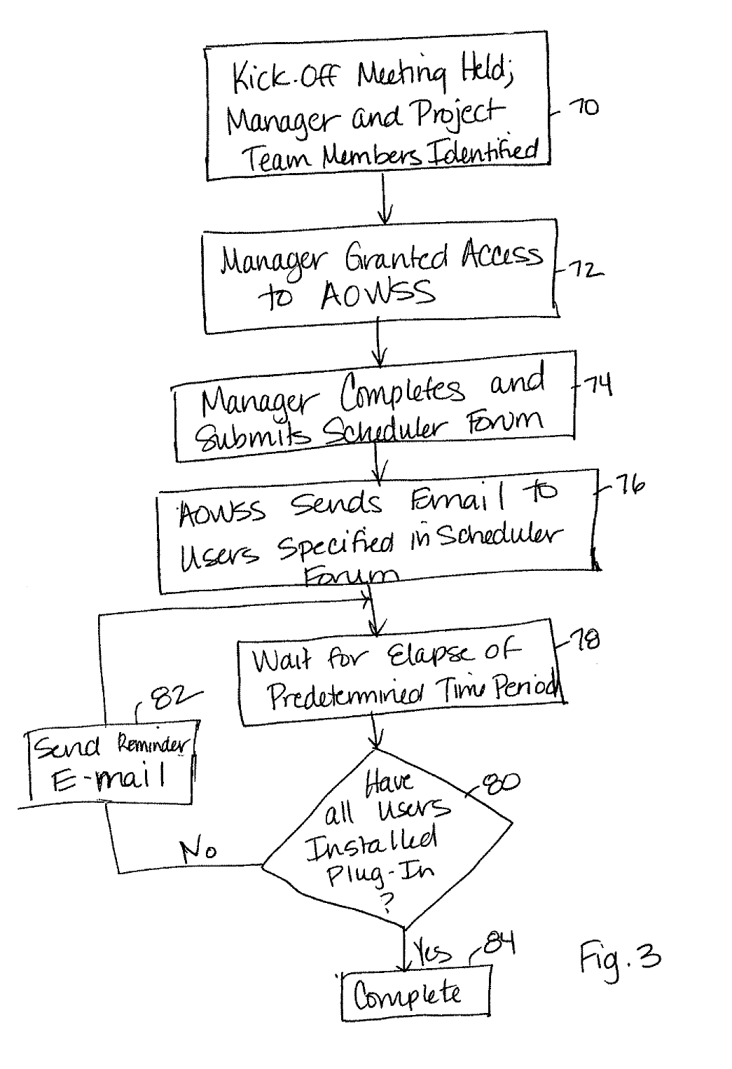

FIG. 3 is a flowchart illustrating creation of a work group using the AOWSS as illustrated in and described with reference to FIG. 2. In step 70, the kick-off meeting is held, during which a manager and team members are identified. In step 72, the manager is granted access to the AOWSS and in step 74, the manager completes and submits the scheduler forum. In step 76, the AOWSS sends an e-mail to all of the work group members (i.e., sponsor, manager, and team members) as specified in the scheduler forum submitted by the manager. The e-mail contains a link to a plug-in associated with the AOWSS. After a predetermined time period has elapsed (step 78), in step 80, the AOWSS determines whether all of the recipients of the e-mail sent in step 76 have installed the plug-in on their computer. If not, in step 82, the AOWSS sends a reminder e-mail to those recipients who have not installed the plug-in on their computer and execution returns to step 78. This process (steps 78-82) is repeated periodically until a determination is made in step 80 that all of the e-mail recipients have installed the plug-in on their computer, in which case execution terminates in step 84.

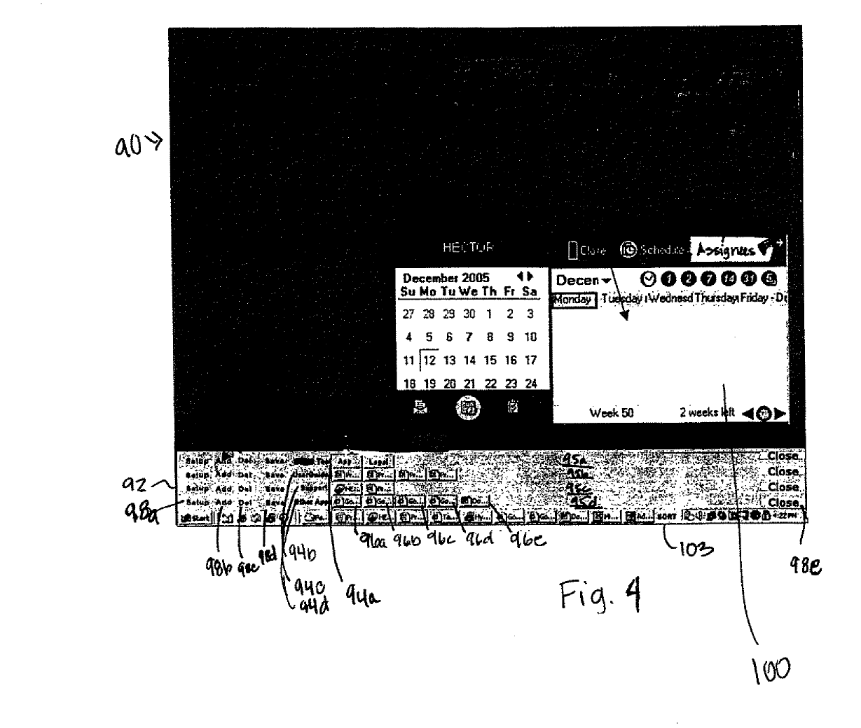

FIG. 4 illustrates an appearance of a manger's desktop environment 90 after the scheduler forum has been used to set up various projects and/or tasks as illustrated in and described with reference to FIGS. 2 and 3. The privileges afforded the manager role result in a management interface 92 of the AOWSS being displayed at the bottom of the desktop environment 90. The sponsor will likely also have access to the management interface 92. Each project or task that has been set up using the scheduler forum (FIG. 2) is represented in the management interface 92 by a button and an associated status bar. In particular, as illustrated in FIG. 4, there are four such buttons, including a “Tool” button 94a, a “UserGuides” button 94b, a “Support” button 94c, and an “Other Applications” button 94d. Each of the buttons 94a-94d has associated therewith a respective status bar 95a-95d. The represented projects or tasks may have associated therewith one or more documents, applications, and/or web pages (hereinafter collectively referred to as “auto-open items”), each of which is represented by a tab displayed in the status bar associated with the corresponding project or task

For example, the status bar 95d of the Other Apps button 94d contains five tabs, respectively designated by reference numerals 96a-96e. It will be assumed for the sake of simplicity and for purposes of example that each of the tabs 96a-96e represents documents. Clicking on the tab 96a results in the document represented by that tab being opened. Clicking on the button 94d results in all of the documents represented by the tabs 96a-96e being opened

Operation and use of the management interface 92 will be now be described with reference to the status bar 95d, although it should be recognized that the various elements of the status bars 95a-95c function in the manner described with respect to corresponding elements of the status bar 95d. Clicking a “Setup” button 98a of the status bar 95d results in the display of a scheduling function window 100. Using the scheduling function window 100, the manager can identify for one or more of the documents represented by the tabs 96a-96e, a time and date the document(s) should be opened and on which work group members' (or “assignees”) computers. The name of each work group member on whose computer the document(s) should be opened at the scheduled date and time is selected from a list of the all of the work group members designated via the scheduler forum (FIG. 2) and displayed in an “Assignees” drop down menu 102 of the scheduling function window 100. At the scheduled time, the AOWSS 30 (FIG. 2) automatically opens and displays (“auto-opens”) the document(s) on the computer of each of the designated work group members based on the PC-ID for the member provided via the scheduler forum (FIG. 2). It will be recognized that, in order for the AOWSS 30 to accomplish this function, the plug-in 56 (FIG. 2) must have previously been installed on the computer of the designated work group member.

Clicking an “Add” button 98b enables the user to add an auto-open item to the status bar 95d and associates that item with the corresponding project or task. Additionally, auto-open items may be “added” to a project or task by clicking and dragging an icon representing the auto-open item to the corresponding status bar. As previously noted, non-personal projects and tasks can only be added via the scheduler forum (FIG. 2). Clicking on a “Del” button 98c results in removal of some or all of the contents of the status bar 95d and disassociates the auto-open items represented by deleted contents from the project or task corresponding to the status bar 95d. It should be noted that the project or task itself represented by the status bar 95d cannot be removed in this manner, as this can only performed by the sponsor or system administrator. The manager can only edit the contents of the status bar 95d. Clicking on a “Save” button 98d saves the contents of the status bar 95d. Clicking on a “Close” button 98e reduces the status bar 95d to an icon in a task bar 103 of the environment 90.

In one embodiment, an auto-open schedule comprising, for each auto-open item to be auto-opened, the time and date the auto-open item is to be auto-opened and information identifying the users on whose computers the auto-open item is scheduled to be auto-opened is maintained by and within the AOWSS 30. In one aspect, when an auto-open item is auto-opened on a team member's computer, some method of confirming that the team member viewed the document/application/web page and/or performed an assigned task is provided. For example, the team member may be required to respond to a query displayed in a pop-up window in connection with the auto-opened document/application/web page. Alternatively, the server may be able to track keystrokes in connection with or modifications to the auto-opened item to determine whether the team member has met certain minimum requirements with respect to same.

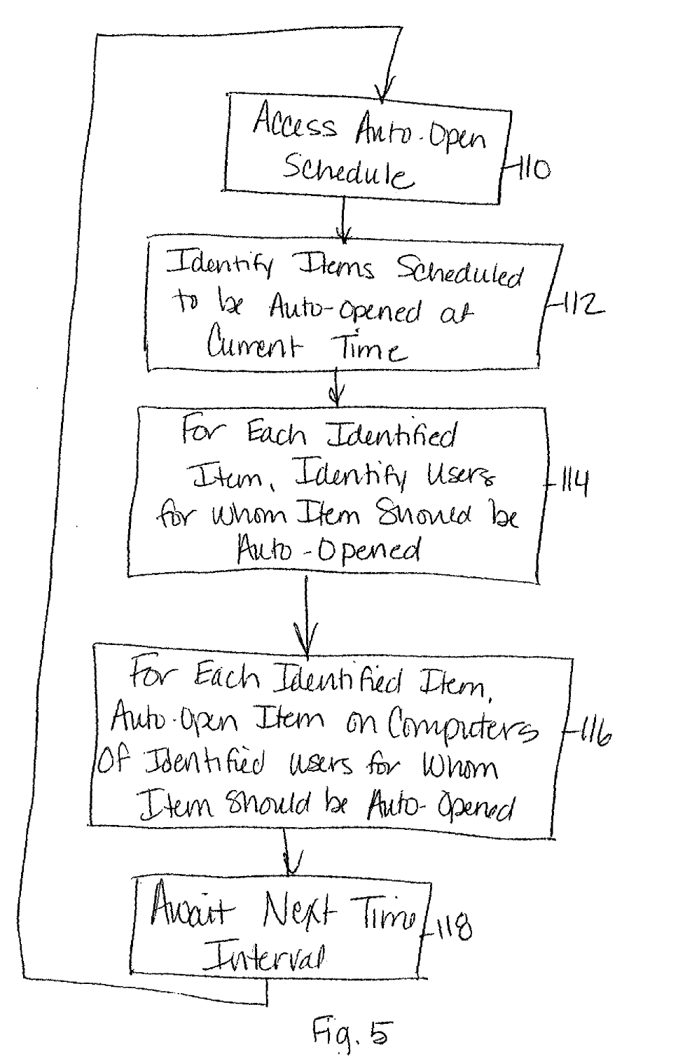

FIG. 5 is a flowchart illustrating operation of an AOWSS, such the AOWSS 30, for auto-opening a scheduled auto-open item in accordance with one embodiment. In step 110, at preselected time intervals (e.g., one minute intervals), the AOWSS checks the auto-open schedule maintained thereby. In step 112, the AOWSS identifies any auto-open item(s) in the auto-open schedule scheduled to be auto-opened at the current time. In step 114, for each of the auto-open items identified in step 112 all users for whom the auto-open item is scheduled to be auto-opened at the current time are identified. Execution then proceeds to step 116 in which, for each of the auto-open items identified in step 110, the auto-open item is opened on computers of the users for whom the auto-open item is scheduled to be auto-opened at the current time. In one embodiment, step 116 is accomplished in the following manner. At the scheduled time, the plug-in installed on the manager's computer activates a AOWSS on the server, which in turn opens the plug-in installed on the computer of each of the designated users. The user' plug-ins pup-up and open a window to the server in which the auto-open item is running. In step 118, the AWOSS awaits the next time interval before returning to step 110.

As previously noted, the AOWSS 30 (FIG. 2) can be used for personal scheduling as well. In such cases, there will be a status bar containing a button designated “Personal” on the managers desktop. This status bar can be managed in much the same way as described with reference to FIGS. 3 and 4, the main difference being that the documents/applications/web pages will be auto-opened on the manager's desktop, rather than on designated team members' desktops, at the scheduled time.

As previously indicated, in one aspect, when an auto-open item is auto-opened on a team member's computer, some method of confirming that the team member viewed the document/application/web page and/or performed an assigned task may be provided. For example, the team member may be required to respond to a query displayed in a pop-up window in connection with the auto-opened document/application/web page. Alternatively, the server may be able to track keystrokes in connection with or modifications to the auto-opened item to determine whether the team member has met certain minimum requirements with respect to same.

While the preceding description shows and describes one or more embodiments, it will be understood by those skilled in the art that various changes in form and detail may be made therein without departing from the spirit and scope of the present disclosure. Therefore, the claims should be interpreted in a broad manner, consistent with the present disclosure.

What is claimed is:

1. A method for implementing an auto-open work scheduler system, the method comprising:
creating a work group comprising a plurality of members, wherein the creating further comprises providing for each of the members an e-mail address and a PC-ID identifying a computer of the member;
sending to each of the members an e-mail message, the e-mail message comprising means for enabling the member to install a plug-in module on a computer of the member, the plug-in module enabling identified items to be automatically opened (“auto-opened”) on the member's computer at a specified date and time;
determining whether all of the members have installed the plug-in module; and
responsive to a determination that at least one of the members has not installed the plug-in module, sending a reminder e-mail message to the at least one of the members.

2. The method of claim 1 wherein the e-mail message includes a link and wherein the member installs the plug-in module by clicking on the link.

3. The method of claim 1 wherein the e-mail message includes a confirm icon and wherein the member clicks on the confirm icon to confirm installation of the plug-in module, the determining further comprising determining whether all of the members have clicked on the confirm icon.

4. The method of claim 1 wherein the creating a work group further comprises completing a scheduler forum.

5. The method of claim 1 wherein at least one of the members is designated as a manager and wherein the creating a work group is performed by the manager.

6. The method of claim 1 wherein for each of the members, the e-mail message is sent to the e-mail address provided for the member.

7. The method of claim 1 further comprising repeating the determining and sending a reminder e-mail message until it is determined that all of the members have installed the plug-in.

8. The method of claim 1 further comprising:
identifying an item to be auto-opened;
selecting a member for whom the identified item is to be auto-opened; and
selecting a date and time at which the identified item is to be auto-opened.

9. The method of claim 8 further comprising opening the identified item on the identified computer of the selected member at the selected date and time.

10. The method of claim 8 wherein the identified item is selected from the group consisting of a document, a web page, and an application.

11. The method of claim 8 further comprising determining whether the selected member has performed a required function in connection with the auto-opened item.

12. The method of claim 11 further comprising reporting to a manager results of the determining whether the selected member has performed a selected function in connection with the auto-opened item.

13. An auto-open work scheduler system comprising:
means for creating a work group comprising a plurality of members, wherein the creating further comprises providing for each of the members an e-mail address and a PC-ID identifying a computer of the member;
means for sending to each of the members an e-mail message, the e-mail message including a link for enabling the member to download from a server a plug-in module and to install the plug-in module on a computer of the member, wherein the plug-in module enables identified items to be automatically opened (“auto-opened”) on the member's computer at a specified date and time;
means for determining whether all of the members have installed the plug-in module; and
means responsive to a determination that at least one of the members has not installed the plug-in module for sending a reminder e-mail message to the at least one of the members.

14. The system of claim 13 wherein the e-mail message further includes a confirm icon and wherein the member clicks on the confirm icon to confirm installation of the plug-in module, the determining further comprising determining whether all of the members have clicked on the confirm icon.

15. The system of claim 13 wherein at least one of the members is designated as a manager and wherein the means for creating a work group further comprises making a scheduler forum available to the manager and wherein the manager creates the work group by completing the scheduler forum and uploading the completed scheduler forum to the computer.

16. The system of claim 13 further comprising repeating the determining and sending a reminder e-mail message until it is determined that all of the members have installed the plug-in.

17. The system of claim 13 further comprising:
means for designating at least one of the members as a manager;
means for enabling the manager to identify an item to be auto-opened;
means for enabling the manager to select at least one member for whom the identified item is to be auto-opened; and
means for enabling the manager to select a date and time at which the identified item is to be auto-opened.

18. The system of claim 17 further comprising means for opening the identified item on the identified computer of the selected member at the selected date and time.

19. The system of claim 17 wherein the identified item is selected from the group consisting of a document, a web page, and an application.

20. The system of claim 17 further comprising means for determining whether the selected member has performed a required function in connection with the auto-opened item.

21. The system of claim 20 further comprising means for reporting to a manager results of the determining whether the selected member has performed a selected function in connection with the auto-opened item.

22. A method for implementing an auto-open work scheduler system, the method comprising:
creating a work group comprising a plurality of members, wherein the creating further comprises providing for each of the members an e-mail address and a PC-ID identifying a computer of the member;
sending to each of the members an e-mail message, the e-mail message comprising means for enabling the member to install a plug-in module on a computer of the member, the plug-in module enabling identified items to be automatically opened (“auto-opened”) on the member's computer at a specified date and time;
determining whether all of the members have installed the plug-in module; and
responsive to a determination that at least one of the members has not installed the plug-in module, sending a reminder e-mail message to the at least one of the members;
subsequent to a determination that all of the members have installed the plug-in module:
identifying an item to be auto-opened;
selecting at least one member for whom the identified item is to be auto-opened; and
selecting a date and time at which the identified item is to be auto-opened.
